(19) United States
(12) Patent Application Publication
(10) Pub. No.: US 2013/0185260 A1
(43) Pub. Date: Jul. 18, 2013

(54) DATA BACKUP AND RESTORAL APPARATUS, SYSTEM, AND METHODS

(71) Applicants: Nathan Daniel Weinstein, Glastonbury, CT (US); Garold C. Miller, Glastonbury, CT (US)

(72) Inventors: Nathan Daniel Weinstein, Glastonbury, CT (US); Garold C. Miller, Glastonbury, CT (US)

(21) Appl. No.: 13/747,672

(22) Filed: Jan. 23, 2013

Related U.S. Application Data
(63) Continuation-in-part of application No. 13/352,036, filed on Jan. 17, 2012.

(51) Int. Cl. G06F 17/30

(52) U.S. Cl. CPC G06F 17/3023
USPC 707/646

(57) ABSTRACT

A method for maintaining incremental backups of a file. The method includes identifying a target file to be backed up. The method also includes comparing the target file to a one or more previously backed up files, in order to identify differences of the target file from a corresponding previously backed up file. The method also includes generating a delta version of the target file that records the identified differences from the previously backed up file.

### CROSS-REFERENCE TO RELATED APPLICATION

This application claims the benefit of U.S. application Ser. No. 13/352,036, filed Jan. 17, 2012, which is incorporated herein by reference.

### BACKGROUND

1. Technical Field

The present invention is generally directed to apparatus and methods for data backup and restoral.

2. Discussion of Art

Data in computer systems may need to be backed up for a variety of reasons, such as facilitating recovery of data lost during computer system failures. Certain systems may store and manage data only locally. Other backup systems may backup locally stored data to a remote device. Typically, backup protocols require saving complete copies of any files to be backed up. Particularly where backup is to a remote device, saving complete copies at every backup can impose unneeded expense.

### SUMMARY

Accordingly, it is desirable to provide backup methods and apparatus that permit incremental backup of data. In aspects of the present invention, a method is provided, e.g., a method for maintaining incremental backups of a file. The method includes identifying a target file to be backed up. The method also includes comparing the target file to xone or more previously backed up files, in order to identify differences of the target file from a corresponding previously backed up file. The method also includes generating a delta version of the target file that records the identified differences from the previously backed up file.

In embodiments of the present invention, an apparatus is provided for maintaining incremental backups of one or more files on a local device. The apparatus includes a data storage device and a connection device for placing the data storage device in communication with the local device. The apparatus is configured to install a backup client program from the data storage device onto the local device. The backup client program configures the local device to initiate a backup protocol when the data storage device is in communication with the local device. The backup protocol includes identifying a target file to be backed up, then comparing the target file to an image built from one or more previous backup layers. The image includes copies of one or more previously backed up files, and the comparison identifies differences of the target file from one of the previously backed up files. The backup protocol then includes generating a delta version of the target file that records the identified differences from the previously backed up file.

In embodiments of the present invention, a device is configured to implement a backup protocol in response to connection of a backup apparatus in communication with the device. The backup protocol includes identifying a file to be backed up; comparing the target file to an image built from one or more previous backup layers, the image including copies of one or more previously backed up files, to identify differences of the target file from one of the previously backed up files; and generating a delta version of the target file that records the identified differences from the previously backed up file.

In aspects of the present invention, a method is provided, e.g., a method for restoring a file from a backup data structure to a local device. The method includes placing the local device in communication with a local backup apparatus that stores a first backup data structure and a backup index, selecting a target file from the backup index, and identifying backup layers of the first backup data structure that contain a complete copy and/or delta versions of the target file. The method then includes compiling the backup layers to build a copy of the target file.

In aspects of the invention, in order to back up a local device (e.g., a Personal Computer, a Tablet, a Personal Digital Assistant, a mobile telephone), a HALO application (a.k.a., the HALO App) is automatically transferred to the local device on attachment of an external USB storage device or wireless storage device (a.k.a., local backup apparatus or HALO Drive). The application (a.k.a., the HALO App) then automatically creates schedules to backup information (files and settings) on a regular basis. Additionally, the application configures the local device to execute a backup protocol on connection of the HALO Drive with the local device. The application (a.k.a., the HALO App) creates two separate backups, one to the onsite local backup apparatus (a.k.a., HALO Drive) and the other to a remote backup system (a.k.a., HALO Cloud). Typically, the backups are created simultaneously to reduce a risk of data being lost or corrupted. Various copies and/or versions of a file are backed up in a layered or incremental fashion. Then selected layers may be retrieved for any, each, or all of the backed up files. For example, at each performance of the backup protocol, the local device identifies one or more target files to be backed up, and compares each of the target files to a compilation of one or more previous backup layers, in order to identify differences of each target file from a previously backed up version of that target file. The local device then generates a current backup layer that records the identified differences as a delta version of the target file.

When restoring a file, a user selects the file to be restored, and the local device then compares the selected file to a listing of backup layers. Based on the listing of backup layers, the local device identifies backup layers within a first data structure that contain changed versions of the selected file. The local device then compiles the changed versions to restore the file.

For PDAs and tablets, the present invention backs up emails, calendar items, contacts, configuration settings, installed applications, text messages, pictures, videos, alarm clock settings, browser settings, call logs, sound and display settings, and user dictionary. As more items become available from the PDA/tablets operating system vendors, those additional items will be added to the backup.

In addition to the local devices as listed above, the HALO App will also install onto internet-connective appliances having USB ports, such as select refrigerators, thermostats, lighting devices, and cable boxes. All of the settings from these devices can be backed up both locally to the HALO Drive and to the HALO Cloud system.

The HALO Cloud system includes a web portal for providing a HALO Control Panel, which enables HALO embedded appliances to be controlled remotely. Examples of this include changing the temperature of a HALO embedded thermostat; turning off HALO embedded lights, and adding items to a shopping list on a HALO embedded refrigerator. These activities can be accomplished remotely merely by accessing one's HALO Cloud portal through existing telecommunications devices.

### BRIEF DESCRIPTION OF THE DRAWINGS

The foregoing summary, as well as the following detailed description of the preferred embodiments, is better understood when read in conjunction with the appended drawings. The enclosed Figures illustrate features of the data backup, storage and management capabilities of the present invention. For the purpose of illustrating the invention, the drawings show embodiments that are presently preferred, it being understood, however, that the invention is not limited to the specific embodiments disclosed. In the drawings:

FIG. 1 is a diagram of a data backup, storage and management system in accordance with an illustrative embodiment of the invention;

FIG. 2 is a flowchart of a backup process according to an embodiment of the present invention;

FIG. 3 shows in schematic view a layered backup data structure;

FIG. 4 is a flowchart of a data restoration process according to an embodiment of the present invention.

### DETAILED DESCRIPTION

The description of embodiments and features of the present invention provide herein and in the appended drawings has been presented for the purpose of illustration and description. It is not intended to be exhaustive or to limit the present invention to the form disclosed. Obvious modifications and variations are possible in light of this disclosure. The embodiments described and illustrated were chosen to best illustrate the principles of the present invention and practical applications thereof to enable one of ordinary skill in the art to utilize the invention in various embodiments and with various modifications as suited to the particular use contemplated.

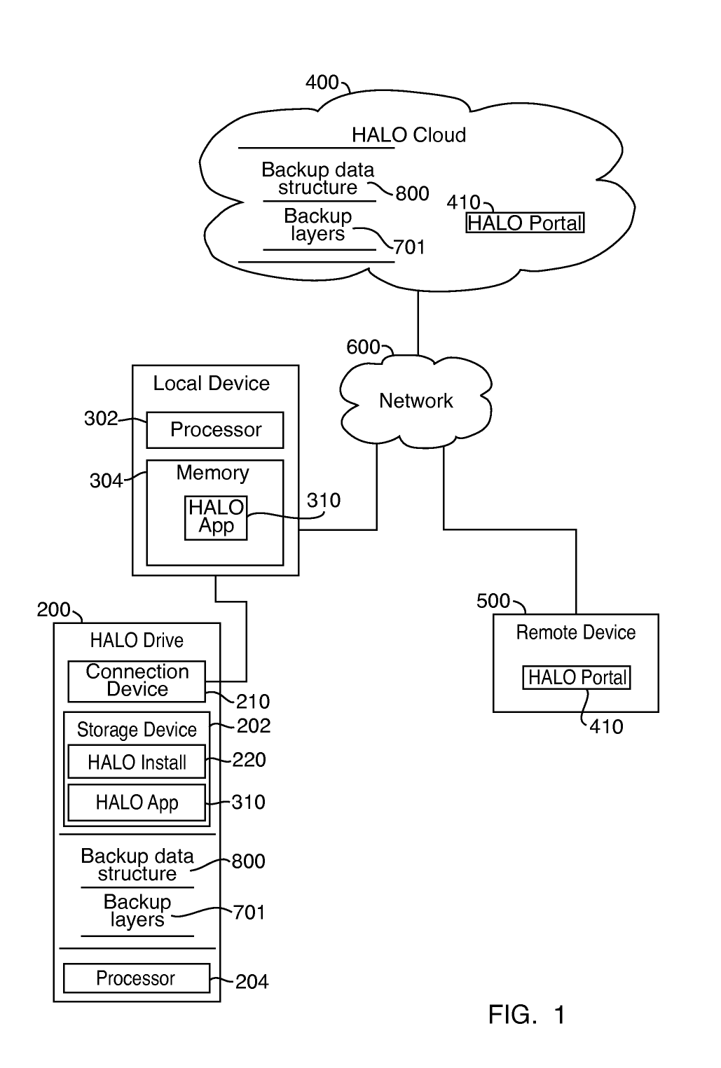

The present application is directed to systems and methods for local and remote data backup, storage and management. In an exemplary embodiment, as illustrated in FIG. 1, a data backup system 100 comprises a local backup apparatus (HALO Drive) 200 and a remote backup system (HALO Cloud) 400, which are in communication with a local device 300 and a computer device 500 via a network 600. The HALO Drive 200 includes a data storage device 202, which is configured with instructions 220 for configuring the local device 300 to backup files to the HALO Drive 200 and/or to the HALO Cloud 400. The HALO Drive 200 also includes a processor 204 for implementing the instructions 220. The HALO Drive 200 is adapted to connect in communication with the local device 300. The local device 300 contains data (files), and is configured to back those files up to the HALO Drive 200 and/or to the HALO Cloud 400. The HALO Cloud 400 provides an online service for managing the files backed up in the HALO Cloud 400. The online service is accessible via any computer device 500 that is connected in communication with the HALO Cloud 400 via the network 600.

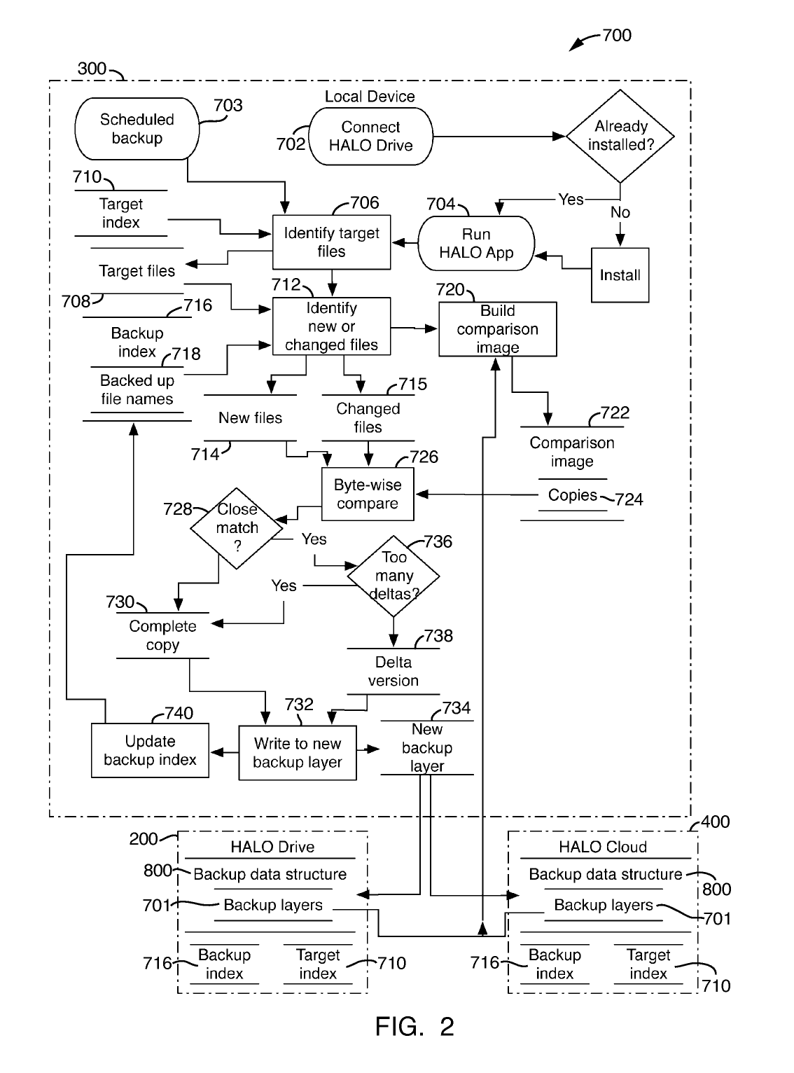

The HALO Drive 200 is preferably a backup drive (HALO Drive) that is adapted to connect in communication with the local device 300, whereby data may be transferred between the HALO Drive 200 and the local device 300. For example, the HALO Drive 200 may include a USB drive or an external disk drive or any equivalent writable data storage device 202. As mentioned above, and further discussed below, the data storage device 202 stores instructions 220 for configuring the local device 300 to implement a HALO App 310. In particular, the HALO Drive 200 stores on the data storage device 202 a DS Client Installer Program (“HALO Install”) 220, as well as a HALO App 310 (DS Client Program or HALO2CLOUD). The HALO Drive 200 also includes a processor 204 for controlling operation of the data storage device 202 and implementing the HALO Install 220. The HALO Drive 200 is adapted to connect to the local device 300 via the connection device 210, which may be a wired connection (e.g., a USB plug connection, FireWire, or the like) and/or a wireless connection (e.g., WiFi, Bluetooth, or the like). Accordingly, in some embodiments, the HALO Drive 200 may include a USB or FireWire connector that connects to a USB or FireWire port in the local device 300. The processor 204 is configured to automatically launch the DS Client Installer Program 220 to install the HALO App 310 on the local device 300, when the HALO Drive 200 is connected with the local device 300. Of course in case the HALO App 310 already is installed, the HALO Drive 200 does not reinstall it. Instead, on connection of the HALO Drive 200 with the local device 300, the HALO App 310 is configured to commence a backup algorithm 700 as shown in FIG. 2.

The local device 300 may be any electronic device that stores data, which a client wishes to backup to the HALO Drive 200 and/or the HALO Cloud 400. For example, the local device 300 may be any type of personal computing device with a network interface, such as, for example, personal computer, smart phone, personal digital assistant (PDA), electronic tablet, or the like. Also, the local device 300 may be an electronic appliance, such as, for example, refrigerator, thermostat, lighting control, cable box, or the like. The local device 300 is adapted to connect to the HALO Drive 200 via a wired or wireless connection 210, such as, for example, USB, FireWire, WiFi, Bluetooth, or the like. Further, the local device 300 includes a processor 302 that is adapted to store and execute, within local memory 304, the HALO App 310, which is data backup management software that performs scheduled and/or event-driven data backups. Further, the local device 300 may be configured to include web-browsing capabilities, whereby the local device 300 can communicate with the web portal 410 of the HALO Cloud 400. The local device 300 is connected to the HALO Cloud 400 via a wired or wireless connection 320 to the network 600.

In addition to accomplishing data backups when the HALO Drive 200 is connected with the local device 300, the HALO App 310 also runs on a schedule to backup data on the local device 300 to the HALO Drive 200 and/or the HALO Cloud 400 by sending a copy of the data on the local device 300 to the HALO Drive 200, and/or to the HALO Cloud 400.

The HALO Cloud 400 may be a conventional computer, or alternatively, the function of the HALO Cloud 400 may be implemented on a cloud computing system having distributed computer architecture for providing an online/cloud backup service, for backing up data from the local devices 300. The HALO Cloud 400 is connected to the local device 300 and to the computer devices 500 via the network 600. The HALO Cloud 400 validates, maintains and manages clients' online backup accounts and data storage. Further, the HALO Cloud 400 provides the web portal 410 (“HALO Portal”) for allowing clients access to and management of their online backup accounts, including access to and management of remote data backups.

Each of the computer devices 500 may be any suitable device that is capable of communication with the HALO Portal 410 via a web browser, such as a personal computer, thin client, PDA, smart phone, or the like. The computer device 500 may be used to communicate with the HALO Cloud 400 via the network 600 and to access a client's online backup account through the HALO Portal 410. Accordingly, a client's online backup account and remote data backups may be accessed using any computer device that is capable of communication with the HALO Portal 410 via a web browser. Although possible, it is not necessary for a client to use the local device 300, whose data is backed up on the HALO Drive 200 and/or the HALO Cloud 400, to access the client's online backup account and remote data backups on the HALO Cloud 400, via the network 600.

The network 600 may be any one or a combination of a Local Area Network (LAN), a Metropolitan Area Network (MAN), a Wide Area Network (WAN), a proprietary network, a Public Switched Telephone Network (PSTN), a Wireless Application Protocol (WAP) network, a BLUETOOTH network, a wireless LAN network, and/or an Internet Protocol (IP) network such as the Internet, an intranet, or an extranet.

It should be understood that the methods described herein are exemplary embodiments of the present invention. Accordingly, in other embodiments, additional steps may be added and/or certain steps may be omitted, as desired. Furthermore, the flow charts described herein do not imply a fixed order to the steps, and embodiments of the present invention may be practiced in any order that is practicable. Note that any of the methods described herein may be performed by hardware, software, or any combination of these approaches. For example, a storage medium may store thereon instructions that when executed by a machine result in performance according to any of the embodiments described herein.

In accordance with one aspect of the invention, the HALO App 310 executes a backup routine 700, as shown in FIG. 2, to establish on the HALO Drive 200 and in the HALO Cloud 400 one or more backup layers 701. The backup routine 700 may be initiated at step 702 by connecting the HALO Drive 200 with the local device 300; or at step 703 by expiration of a scheduled time period; or at step 704 by selecting a backup feature within the HALO App 310.

At step 706, the HALO App 310 identifies files 708 that are to be backed up (“target files” 708). The HALO App 310 identifies the target files 708 by reference to a target index 710, which lists the names of the target files 708 along with metadata such as “last modified” date/time stamps.

At step 712, the HALO App 310 identifies target files 708 that may not have been previously backed up (“new files” 714) as well as those that may have changed from a previous backup (“changed files” 715). The HALO App 310 identifies the new files 714 and the changed files 715 by comparing the target index 710 to a backup index 716. The backup index 716 lists the names 718 of backed up files that are backed up in previous backup layers 701. The backup index 716 also lists, for each backed up file, a “last modified” date/time stamp along with a delta version number. The delta version number indicates how many delta versions of the backed up file 718 have been previously stored. Delta versions are further explained below with reference to step 726. At step 712, the HALO App 310 compares target file(s) 708 to file names 718, in order to identify new files 714 that are listed in the target index 710 but are not listed within the backup index 716. The HALO App 310 also compares date/time stamps of files that are listed both in the target index 710 and in the backup index 716, in order to identify changed files 715 that have been modified since the most recent backup layer 701.

At step 720, the HALO App 310 then builds a comparison image 722 in local memory 304. The HALO App 310 builds the comparison image 722 by compiling previous backup layers 701, based on the backup index 716, in order to generate a complete file copy 724 corresponding to each file name 718 that is listed in the backup index 716.

For each new file 714 or changed file 715, the HALO App 310 then undertakes step 726 of conducting a byte-wise comparison to selected ones of the copies 724 within the comparison image 722. At step 728, the HALO App 310 checks whether there is a “close match” or a copy 724 that is substantially similar to the new file 714 or to the changed file 715. For any changed file 715, the close match will be the copy 724 having the same file name. For files tagged as new files 714, a “substantially similar” copy 724 will differ by no more than a pre-determined number or percentage of bytes, by length and/or by substitution. For example, substantially similar files may differ by no more than five percent (5%) of the total bytes of the longer file.

In case no close match is found at step 728, the HALO App 310 generates a complete copy 730 of the new file 714, and at step 732, writes the complete copy 730 to a new backup layer 734. On the other hand, if a close match is found at step 728, then the HALO App 310 checks at step 736 how many previous “delta versions” have been made for this changed file 715. In case too many delta versions have been made, then the HALO App 310 generates a completely copy 730 and proceeds to step 732. On the other hand, if not too many delta versions have been made, then the HALO App 310 generates a “delta version” 738 that identifies the byte-wise differences between the changed file 715 and its corresponding close match copy 724. At step 732, these delta versions 738 are added to the new backup layer 734.

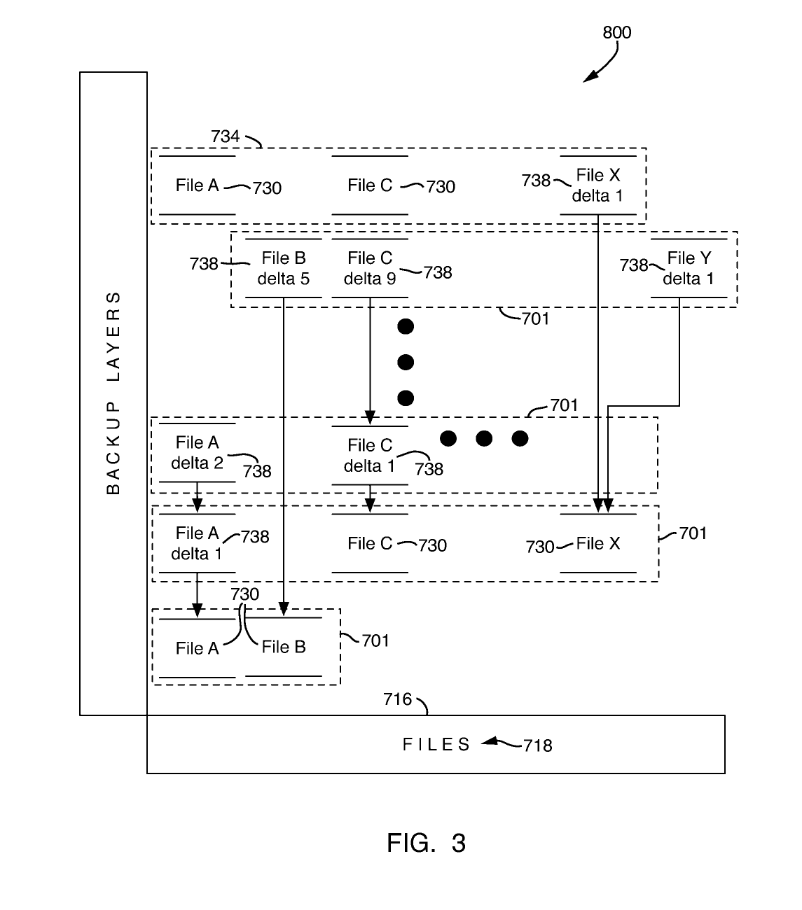

For example, if a new file 714 had the filename “FILE_Y.doc” (not found in the backup index 716), then at step 726 the HALO App 310 would compare the bytes of “FILE_Y.doc” to the bytes of each copy 724. In case the bytes of a copy 724, having the filename “FILE_X.doc,” were substantially similar to the bytes of “FILE_Y.doc,” then the HALO App 310 would categorize “FILE_X.doc” as a close match 728. The HALO App 310 also would re-categorize “FILE_Y.doc” from a new file 714 to a changed file 715, and would generate for “FILE_Y.doc” a delta version 730. FIG. 3 illustrates how this would look in terms of dependencies between backup layers 701. For example, if the newly-updated target file “FILE_Y.doc” differed from a previously backed up file “FILE_X.doc” by only thirty bytes midway through the files, then the corresponding delta version “FILE Y delta 1” simply would list those thirty bytes along with their relative location within the files.

Referring again to FIG. 2, at step 740, the HALO App 310 updates the backup index 716 to include information for the new backup layer 734.

As part of step 732, which generates the new backup layer 734, the HALO App 310 incrementally writes the new backup layer 734 to a backup data structure 800. The backup data structure 800 is mirrored in the HALO Drive 200, and in the HALO Cloud 400. In case the HALO Drive 200 is not available then the backup layer 734 is written only to the HALO Cloud 400; in case the HALO Cloud 400 is not available then the backup layer 734 is written only to the HALO Drive 200. At each initiation of backup, the copy of backup data structure 800, stored in the HALO Drive 200, is synchronized with the copy of backup data structure 800, stored in the HALO Cloud 400.

The backup algorithm 700, as described above, is particularly advantageous for backing up certain types of files. For example, large relational databases may generate many versions of the same file. It is advantageous to store these numerous versions as delta versions 730, rather than as complete copies 740. As another example, consecutive still frames of a video image sequence may differ by only a few details. It is advantageous to store the sequence of images as a series of delta versions 730, rather than as a series of complete copies 740. Generation of the backup layers 701 to include delta versions 730, in preference over complete copies 740, is particularly advantageous where the backup layers 701 will be stored both locally and remotely, as the delta versions 730 reduce bandwidth usage relative to the complete copies 740.

FIG. 3 illustrates the backup data structure 800 that is established both in the HALO Drive 200 and in the HALO Cloud 400. The backup data structure 800 includes the backup layers 701, each layer including one or more delta versions 730 along with one or more complete copies 740. The backup data structure 800 also includes a copy of the backup index 716. Elements or the entirety of the backup data structure 800 may be compressed and/or encrypted for storage optimization and data security.

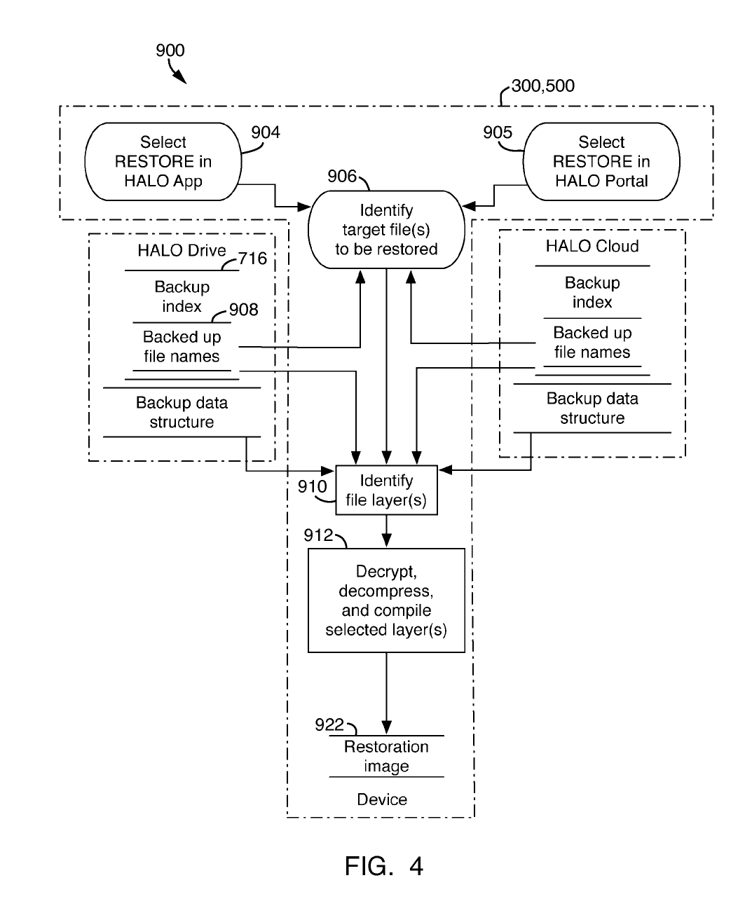

FIG. 4 shows a data restoration algorithm 900, which can be accomplished either on the local device 300 or on any computing device 500 that has access to the HALO App 310. For example, the HALO App 310 can be accessed from the HALO Drive 200, or from the HALO Portal 410.

The algorithm 900 can be initiated from the local device 300 at step 904 of selecting RESTORE in the HALO App (the HALO App 310), or from any computing device 300 or 500 at step 905 of selecting RESTORE in the HALO web portal (HALO Portal 410).

At step 906, the user selects from the backup index 716 (on the HALO Drive 200, the local device 300, or the HALO Cloud 400) names 908 of one or more target file(s) to be restored from the HALO Drive 200 and/or the HALO Cloud 400 to the device 300 or 500.

At step 910, the HALO App 310 on the local device 300, or the web portal 410 on the computing device 500, refers to the backup index 716 in order to identify cumulative backup layer(s) 701 that should be retrieved from the backup data structure(s) 800 in the HALO Drive 200 and the HALO Cloud 400, in order to compile a restoration image 922. At step 912, the HALO App 310 retrieves, decrypts, decompresses, and compiles to selected backup layer(s) 701 to produce the restoration image 922, which is stored on the device 300 or 500.

In select embodiments, the most recent layer 734 is first retrieved, and only enough layers 701 are retrieved as needed to obtain complete copies 924 of the target files 908. Thus, the restoration image 922 need not be the same as the comparison image 722, discussed above. In particular, where fewer than all of the files in the backup index 716 need to be restored, then the restoration image 922 does not need to include all of the backup layers 701 that would be needed to build the comparison image 722.

Variations and improvements of the above examples may occur to those of skill in view of the instant disclosure. Accordingly, the appended claims are intended to encompass what is expressly stated, as well as that which will be apparent from the express disclosure.

What is claimed is:

1. A method for maintaining incremental backups of a file, comprising:
identifying a target file to be backed up;
comparing the target file to one or more previously backed up files, to identify differences of the target file from one of the previously backed up files; and
generating a delta version of the target file that records the identified differences from the previously backed up file.

2. A method as claimed in claim 1, further comprising writing the delta version to a current backup layer in a first backup data structure.

3. A method as claimed in claim 2, further comprising retrieving the one or more previously backed up files from the first backup data structure.

4. A method as claimed in claim 1, wherein the identified differences include additional or substituted bytes.

5. A method as claimed in claim 1, wherein the identified differences include a change of file name.

6. A method as claimed in claim 1, further comprising generating a restoration image from one or more previous backup layers in a first backup data structure, comparing the target file to the restoration image to identify a close match of the target file, and selecting the close match as the previously backed up file for generating the delta version.

7. A method as claimed in claim 6, wherein comparing the target file to the restoration image includes comparing the target file to each backed up file within the restoration image.

8. A method as claimed in claim 1, further comprising comparing the target file to a backup index, in order to identify the previously backed up file for generating the delta version.

9. An apparatus for maintaining incremental backups of one or more files on a local device, said apparatus comprising:
a data storage device; and
a connection device for placing the data storage device in communication with the local device;
said apparatus configured to install a backup client program from the data storage device onto the local device, said backup client program configuring the local device to initiate a backup protocol when the data storage device is in communication with the local device, said backup protocol including:
identifying a target file to be backed up;
comparing the target file to a restoration image built from one or more previous backup layers, the restoration image including copies of one or more previously backed up files, to identify differences of the target file from one of the previously backed up files; and
generating a delta version of the target file that records the identified differences from the previously backed up file.

10. An apparatus as claimed in claim 9, wherein the backup protocol also includes writing the delta version to a current backup layer.

11. An apparatus as claimed in claim 10, wherein the backup protocol also includes accessing a first backup data structure on the data storage device to retrieve the previous backup layers and to store the current backup layer in the first backup data structure.

12. An apparatus as claimed in claim 9, wherein the identified differences include additional or substituted bytes.

13. An apparatus as claimed in claim 9, wherein the identified differences include a change of file name.

14. An apparatus as claimed in claim 9, wherein the backup protocol also includes comparing the target file to the restoration image to identify a close match of the target file, and selecting the close match as the previously backed up file for generating the delta version.

15. An apparatus as claimed in claim 14, wherein comparing the target file to the restoration image includes comparing the target file to each backed up file within the restoration image.

16. An apparatus as claimed in claim 9, wherein the backup protocol also includes comparing the target file to a backup index, in order to identify the previously backed up file for generating the delta version.

17. An apparatus as claimed in claim 16, wherein the backup protocol also includes presenting an option to restore a file from the first backup data structure.

18. An apparatus as claimed in claim 9, wherein upon user selection of the option to restore, the backup protocol also includes identifying backup layers of the first backup data structure that contain changed versions of the selected file, and compiling the changed versions to restore the selected file.

19. A device configured to implement a backup protocol in response to connection of a backup apparatus in communication with said device, said backup protocol including:
identifying a target file to be backed up;
comparing the target file to a restoration image built from one or more previous backup layers, the restoration image including copies of one or more previously backed up files, to identify differences of the target file from one of the previously backed up files; and
generating a delta version of the target file that records the identified differences from the previously backed up file.

20. A device as claimed in claim 19, wherein the backup protocol also includes writing the delta version to a current backup layer.

21. A device as claimed in claim 20, wherein the backup protocol also includes accessing a first backup data structure on the data storage device to retrieve the previous backup layers and to store the current backup layer in the first backup data structure.

22. A device as claimed in claim 19, wherein the identified differences include additional or substituted bytes.

23. A device as claimed in claim 19, wherein the identified differences include a change of file name.

24. A device as claimed in claim 19, wherein the backup protocol also includes comparing the target file to the restoration image to identify a close match of the target file, and selecting the close match as the previously backed up file for generating the delta version.

25. A device as claimed in claim 24, wherein comparing the target file to the restoration image includes comparing the target file to each backed up file within the restoration image.

26. A device as claimed in claim 19, wherein the backup protocol also includes comparing the target file to a backup index, in order to identify the previously backed up file for generating the delta version.

27. A device as claimed in claim 26, wherein the device also is configured to present an option to restore a file from the first backup data structure.

28. A device as claimed in claim 27, wherein upon user selection of the option to restore a file, the device is configured to identify one or more backup layers of the first backup data structure that contain a complete copy and delta versions of the file, and to compile the backup layers to build a copy of the file.

29. A method for restoring a target file from a backup data structure to a local device, comprising:
placing the local device in communication with a local backup apparatus storing a first backup data structure and a backup index;
selecting the target file from the backup index;
identifying one or more backup layers of the first backup data structure that contain a complete copy and/or delta versions of the target file; and
compiling the backup layers to build a copy of the target file.
